(19) United States
(12) Patent Application Publication
(10) Pub. No.: US 2026/0241833 A1
(43) Pub. Date: Aug. 20, 2026

(54) BI-DIRECTIONAL POWER TRANSFER FOR ELECTRIC VEHICLES

(71) Applicant: GM Global Technology Operations LLC, Detroit, MI (US)

(72) Inventors: Minh-Khai Nguyen, Troy, MI (US); Thomas K. Duhon, Fenton, MI (US)

(21) Appl. No.: 19/054,101

(22) Filed: Feb. 14, 2025

(51) Int. Cl. B60L 55/00; B60L 53/16; B60L 53/22; H02J 3/32

(52) U.S. Cl. CPC B60L 55/00; B60L 53/16; B60L 53/22; H02J 3/322; B60L 2210/20

(57) ABSTRACT

A power electronics system for a vehicle may include a vehicle charging inlet. The power electronics system further may include a vehicle-to-load (V2L) electrical outlet for providing AC power to an external device. The V2L electrical outlet is in electrical communication with the vehicle charging inlet. The power electronics system further may include a bi-directional on-board charging module (OBCM) in electrical communication a battery of the vehicle. The bi-directional OBCM is also in electrical communication with the vehicle charging inlet and the V2L electrical outlet. The power electronics system further may include an alternating current (AC) to AC converter in electrical communication with the vehicle charging inlet, the V2L electrical outlet, and the bi-directional OBCM. The power electronics system further may include a new North American Charging Standard (NACS) inlet for providing a neutral connection to a load while maintaining backwards compatibility with electric vehicle supply equipment (EVSE).

### INTRODUCTION

The present disclosure relates to systems and methods for bidirectional power transfer for electric vehicles.

To enable power flow between electric vehicles and external systems, bidirectional power electronics modules may be utilized. These modules are self-contained power-electronic devices typically including semiconductor switches configured to be controllable to accomplish power transfer tasks such as, for example, direct current (DC) to alternating current (AC) conversion, AC to DC conversion, DC to DC conversion, and/or the like. In some examples, bidirectional power electronics modules are configured to interface with a vehicle’s battery and an external power system, allowing for energy discharge to a home (i.e., vehicle-to-home (V2H) features) or to the electrical grid (i.e., vehicle-to-grid (V2G) features). When operating in a V2H mode, the module can supply backup power during outages or provide supplemental energy during peak demand periods. In V2G applications, the module can help stabilize the grid by dynamically adjusting power output based on grid conditions. Furthermore, bidirectional power electronics modules may be configured to provide energy to external AC loads such as portable electronic devices, tools, lights, and/or the like.

While systems and methods for bidirectional power transfer for electric vehicles achieve their intended purpose, there is a need for new and improved vehicle power electronics systems and methods for electric vehicles.

### SUMMARY

According to several aspects, a power electronics system for a vehicle is provided. The power electronics system may include a vehicle charging inlet including a first line inlet terminal, a second line inlet terminal, and a neutral inlet terminal. The power electronics system further may include a vehicle-to-load (V2L) electrical outlet for providing AC power to an external device. The V2L electrical outlet includes a first line V2L terminal, a second line V2L terminal, and a neutral V2L terminal in electrical communication with the vehicle charging inlet. The power electronics system further may include a bi-directional on-board charging module (OBCM) in electrical communication a battery of the vehicle. The power electronics system further may include an alternating current (AC) to AC converter in electrical communication with the vehicle charging inlet, the V2L electrical outlet, and the bi-directional OBCM.

In another aspect of the present disclosure, the power electronics system further may include a switch matrix connecting the V2L electrical outlet to the vehicle charging inlet, the AC to AC converter, and the bi-directional OBCM, the switch matrix including a plurality of electrically controllable switches for operating the power electronics system in a single-phase mode or a split-phase mode. The power electronics system further may include a first line bus connecting the first line inlet terminal of the vehicle charging inlet to the first line V2L terminal of the V2L electrical outlet and a first OBCM terminal of the bi-directional OBCM. The power electronics system further may include a second line bus connecting the second line inlet terminal of the vehicle charging inlet to the second line V2L terminal of the V2L electrical outlet and a second OBCM terminal of the bi-directional OBCM. The power electronics system further may include a neutral bus connecting the neutral inlet terminal of the vehicle charging inlet to the neutral V2L terminal of the V2L electrical outlet.

In another aspect of the present disclosure, in the split-phase mode, the V2L electrical outlet is configured to simultaneously provide both a single-phase AC voltage between either the first line V2L terminal or the second line V2L terminal and the neutral V2L terminal and a split-phase AC voltage between the first line V2L terminal and the second line V2L terminal.

In another aspect of the present disclosure, in the split-phase mode, the vehicle charging inlet is configured to simultaneously provide both a single-phase AC voltage between either the first line inlet terminal or the second line inlet terminal and the neutral inlet terminal and a split-phase AC voltage between the first line inlet terminal and the second line inlet terminal.

In another aspect of the present disclosure, the plurality of electrically controllable switches further includes a first electrically controllable switch configured to connect and disconnect the neutral bus to the second line bus. The plurality of electrically controllable switches further includes a second electrically controllable switch configured to connect and disconnect the second line V2L terminal to the second line bus.

In another aspect of the present disclosure, the plurality of electrically controllable switches further includes a third electrically controllable switch configured to connect and disconnect the neutral V2L terminal and the first electrically controllable switch to the neutral bus. The plurality of electrically controllable switches further includes a fourth electrically controllable switch configured to connect and disconnect the first line V2L terminal to the first line bus. The plurality of electrically controllable switches further includes a fifth electrically controllable switch configured to connect and disconnect the neutral bus to a vehicle chassis ground.

In another aspect of the present disclosure, the power electronics system further includes a controller in electrical communication with the bi-directional OBCM, the AC to AC converter, and the plurality of electrically controllable switches. The controller is programmed to configure the bi-directional OBCM, the AC to AC converter, and the plurality of electrically controllable switches to operate in one of: the single-phase mode and the split-phase mode to transfer energy from the bi-directional OBCM to the vehicle charging inlet and/or the V2L electrical outlet to provide a vehicle-to-home (V2H) feature and/or a vehicle-to-load (V2L) feature. The controller is further programmed to configure the bi-directional OBCM, the AC to AC converter, and the plurality of electrically controllable switches to operate in one of: the single-phase mode and the split-phase mode to transfer energy from the vehicle charging inlet to the bi-directional OBCM to provide a vehicle battery charging feature.

In another aspect of the present disclosure, to operate in the single-phase mode, the controller is further programmed to close the first electrically controllable switch and open the second electrically controllable switch. To operate in the split-phase mode, the controller is further programmed to open the first electrically controllable switch and close the second electrically controllable switch.

In another aspect of the present disclosure, the vehicle charging inlet further includes a North American Charging System (NACS) inlet including the first line inlet terminal, the second line inlet terminal, and the neutral inlet terminal.

In another aspect of the present disclosure, the neutral inlet terminal is disposed substantially in a center of the NACS inlet. The NACS inlet is backwards compatible with NACS connectors without neutral terminals.

According to several aspects, a method for operating a vehicle power electronics system is provided. The method may include connecting a building electrical panel to a vehicle charging inlet of the vehicle power electronics system. The vehicle power electronics system includes the vehicle charging inlet including a first line inlet terminal, a second line inlet terminal, and a neutral inlet terminal, a bi-directional on-board charging module (OBCM) in electrical communication a battery of the vehicle. The bi-directional OBCM includes a first OBCM terminal and a second OBCM terminal in electrical communication with the vehicle charging inlet, and an alternating current (AC) to AC converter in electrical communication with the vehicle charging inlet and the bi-directional OBCM. The method further may include operating the vehicle power electronics system in one of: a single-phase mode and a split-phase mode. In the split-phase mode, the vehicle charging inlet is configured to simultaneously provide or receive both a single-phase AC voltage to or from the building electrical panel between either the first line inlet terminal or the second line inlet terminal and the neutral inlet terminal and a split-phase AC voltage to or from the building electrical panel between the first line inlet terminal and the second line inlet terminal. The method further may include transferring energy from the battery of the vehicle to the building electrical panel using the vehicle power electronics system to provide power to the building electrical panel.

In another aspect of the present disclosure, the method further may include connecting the vehicle charging inlet to the bi-directional OBCM with a first line bus connecting the first line inlet terminal of the vehicle charging inlet to the first OBCM terminal of the bi-directional OBCM and the AC to AC converter, a second line bus connecting the second line inlet terminal of the vehicle charging inlet to the second OBCM terminal of the bi-directional OBCM and the AC to AC converter, and a neutral bus connecting the neutral inlet terminal of the vehicle charging inlet to the AC to AC converter.

In another aspect of the present disclosure, operating the vehicle power electronics system in the single-phase mode further may include closing a first electrically controllable switch. The first electrically controllable switch is configured to connect and disconnect the neutral bus to the second line bus.

In another aspect of the present disclosure, operating the vehicle power electronics system in the split-phase mode further may include opening a first electrically controllable switch. The first electrically controllable switch is configured to connect and disconnect the neutral bus to the second line bus.

In another aspect of the present disclosure, the method further may include transferring energy from the battery of the vehicle to an external device using a vehicle-to-load (V2L) electrical outlet. The V2L electrical outlet includes a first line V2L terminal in electrical communication with the first line bus, a second line V2L terminal in electrical communication with the second line bus, and a neutral V2L terminal in electrical communication with the neutral bus. In the split-phase mode, the V2L electrical outlet is configured to simultaneously provide both a single-phase AC voltage between either the first line V2L terminal or the second line V2L terminal and the neutral V2L terminal and a split-phase AC voltage between the first line V2L terminal and the second line V2L terminal.

In another aspect of the present disclosure, connecting the building electrical panel to the vehicle charging inlet further may include connecting the building electrical panel to the vehicle charging inlet using a North American Charging System (NACS) connector in electrical communication with the building electrical panel. The NACS connector includes a first line connector terminal configured to contact the first line inlet terminal of the vehicle charging inlet, a second line connector terminal configured to contact the second line inlet terminal of the vehicle charging inlet, and a neutral connector terminal configured to contact the neutral inlet terminal of the vehicle charging inlet.

In another aspect of the present disclosure, the method further may include transferring energy from the building electrical panel to the battery of the vehicle using the vehicle power electronics system to charge the battery of the vehicle.

According to several aspects, a power electronics system for a vehicle is provided. The power electronics system may include a North American Charging System (NACS) inlet including a first line inlet terminal, a second line inlet terminal, and a neutral inlet terminal. A center of the neutral inlet terminal is substantially equidistant from a center of the first line inlet terminal and a center of the second line inlet terminal. The NACS inlet is configured to simultaneously provide or receive both a single-phase AC voltage between either the first line inlet terminal or the second line inlet terminal and the neutral inlet terminal and a split-phase AC voltage between the first line inlet terminal and the second line inlet terminal. The power electronics system further may include a vehicle-to-load (V2L) electrical outlet for providing AC power to an external device. The V2L electrical outlet includes a first line V2L terminal, a second line V2L terminal, and a neutral V2L terminal in electrical communication with the NACS inlet. The power electronics system further may include a bi-directional on-board charging module (OBCM) in electrical communication a battery of the vehicle. The bi-directional OBCM includes a first OBCM terminal and a second OBCM terminal in electrical communication with the NACS inlet and the V2L electrical outlet. The power electronics system further may include an alternating current (AC) to AC converter in electrical communication with the NACS inlet, the V2L electrical outlet, and the bi-directional OBCM. The power electronics system further may include a switch matrix connecting the V2L electrical outlet to the NACS inlet, the AC to AC converter, and the bi-directional OBCM, the switch matrix including a plurality of electrically controllable switches for operating the power electronics system in a single-phase mode or a split-phase mode.

In another aspect of the present disclosure, the power electronics system further may include a first line bus connecting the first line inlet terminal of the NACS inlet to the first line V2L terminal of the V2L electrical outlet and the first OBCM terminal of the bi-directional OBCM. The power electronics system further may include a second line bus connecting the second line inlet terminal of the NACS inlet to the second line V2L terminal of the V2L electrical outlet and the second OBCM terminal of the bi-directional OBCM. The power electronics system further may include a neutral bus connecting the neutral inlet terminal of the NACS inlet to the neutral V2L terminal of the V2L electrical outlet. The power electronics system further may include a first electrically controllable switch configured to connect and disconnect the neutral bus to the second line bus. The power electronics system further may include a second electrically controllable switch configured to connect and disconnect the second line V2L terminal to the second line bus.

In another aspect of the present disclosure, the power electronics system further may include a controller in electrical communication with the bi-directional OBCM, the AC to AC converter, and the plurality of electrically controllable switches. The controller is programmed to close the first electrically controllable switch and open the second electrically controllable switch to operate the power electronics system in the single-phase mode. The controller is further programmed to open the first electrically controllable switch and close the second electrically controllable switch to operate the power electronics system in the split-phase mode.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a vehicle power electronics system, according to an exemplary embodiment;

FIG. 2 is a schematic diagram of a power electronics module, according to an exemplary embodiment;

FIG. 3 is a schematic diagram of a new type of North American Charging System (NACS) inlet including a neutral inlet terminal, according to an exemplary embodiment;

FIG. 4 is a schematic diagram of a new type of NACS connector including a neutral connector terminal, according to an exemplary embodiment; and

FIG. 5 is a flowchart of a method for operating the vehicle power electronics system, according to an exemplary embodiment.

### DETAILED DESCRIPTION

The following description is merely exemplary in nature and is not intended to limit the present disclosure, application, or uses.

In aspects of the present disclosure, battery electric vehicles can act as a power source for buildings such as residential or commercial buildings by providing vehicle-to-home (V2H) and/or vehicle-to-grid (V2G) features. Accordingly, the present disclosure provides a new and improved vehicle power electronics system and method for operating the system which provides a neutral connection to the connected building, reducing the need for additional external equipment to facilitate vehicle-to-home (V2H) and/or vehicle-to-grid (V2G) features.

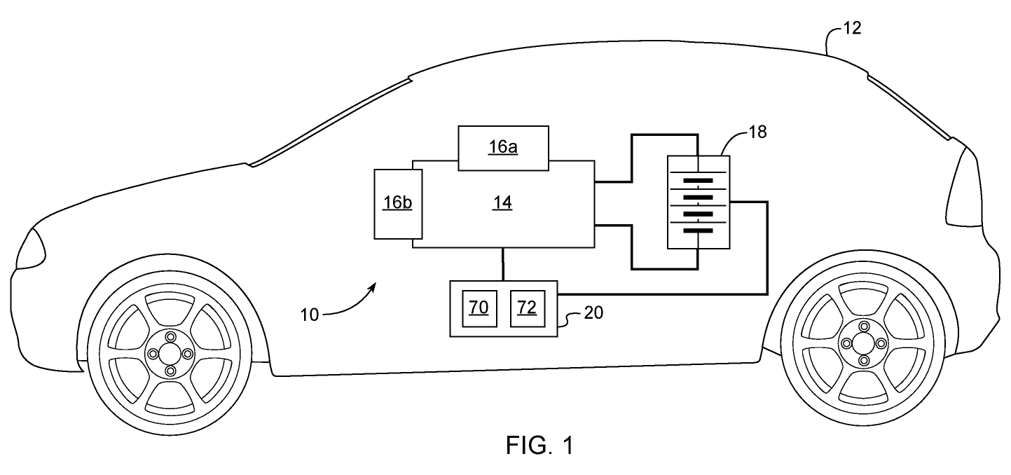

Referring to FIG. 1, a vehicle power electronics system is illustrated and generally indicated by reference number 10. The system 10 is shown with an exemplary vehicle 12. While a passenger vehicle is illustrated, it should be appreciated that the vehicle 12 may be any type of vehicle without departing from the scope of the present disclosure. The system 10 generally includes a power electronics module 14 having a vehicle charging inlet 16a and a vehicle-to-load (V2L) electrical outlet 16b. The system 10 also generally includes a battery 18 and a controller 20.

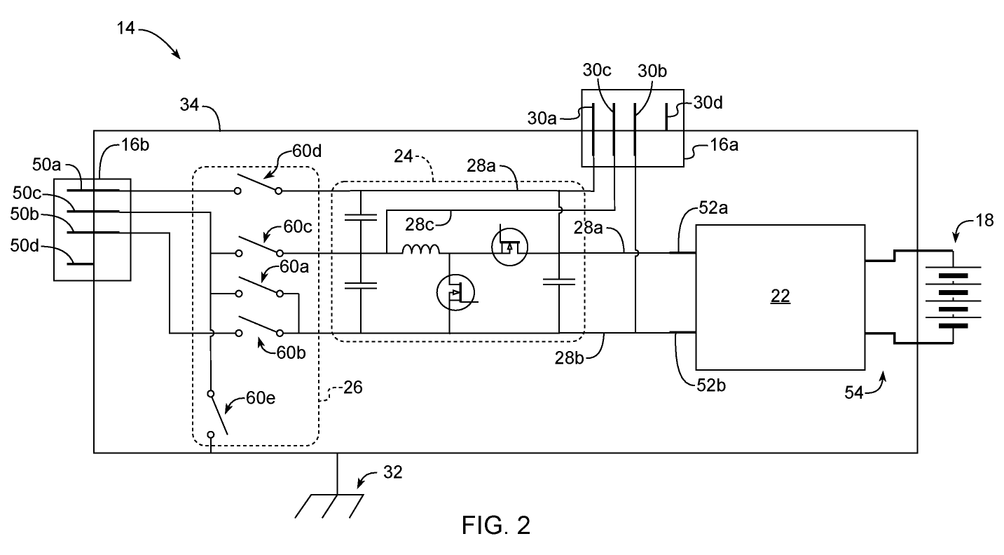

Referring to FIG. 2, a schematic diagram of the power electronics module 14 is shown. In an exemplary embodiment, the power electronics module 14 includes the vehicle charging inlet 16a, the V2L electrical outlet 16b, a bi-directional on-board charging module (OBCM) 22, an alternating current (AC) to AC converter 24, and a switch matrix 26. The components of the power electronics module 14 are connected by a first line bus 28a, a second line bus 28b, and a neutral bus 28c, as will be discussed in greater detail below.

The vehicle charging inlet 16a is used to transfer energy between the vehicle 12 and electrical vehicle supply equipment (EVSE) (not shown). In the scope of the present disclosure, EVSE includes devices configured to connect to vehicles to provide energy to vehicles (i.e., charging) and/or to receive energy from vehicles (i.e., discharging, for example, in vehicle-to-load (V2L), vehicle-to-home (V2H), and/or vehicle-to-grid (V2G) applications). EVSE may be installed in residential homes, commercial businesses, public parking areas, dedicated public or private charging stations, and/or the like. For example, the vehicle charging inlet 16a is used to receive energy from EVSE to charge the battery 18. In another example, the vehicle charging inlet 16a is used to provide energy from the battery 18 to the EVSE to power connected homes, businesses, infrastructure, and/or the electric grid (also known as vehicle-to-home (V2H) operation and/or vehicle-to-grid (V2G) operation).

In an exemplary embodiment, the vehicle charging inlet 16a includes a first line inlet terminal 30a, a second line inlet terminal 30b, a neutral inlet terminal 30c, and a protective earth (PE) inlet terminal 30d. The first line inlet terminal 30a is connected to the first line bus 28a, the second line inlet terminal 30b is connected to the second line bus 28b, the neutral inlet terminal 30c is connected to the neutral bus 28c, and the PE inlet terminal 30d is connected to a vehicle chassis ground 32 of the vehicle 12 via, for example, an outer casing 34 of the power electronics module 14. In an exemplary embodiment, the vehicle charging inlet 16a further includes a plurality of internal switches (not shown) configured to allow the first line inlet terminal 30a, the second line inlet terminal 30b, and the neutral inlet terminal 30c to be connected/disconnected to/from the first line bus 28a, the second line bus 28b, and the neutral bus 28c, respectively.

The power electronics module 14 can operate in a single-phase mode or a split-phase mode. In the single-phase mode, the vehicle charging inlet 16a provides/receives a single-phase AC voltage (e.g., 120 Vac) between the first line inlet terminal 30a and the neutral inlet terminal 30c or between the second line inlet terminal 30b and the neutral inlet terminal 30c. In the split-phase mode, the vehicle charging inlet 16a simultaneously provides/receives the single-phase AC voltage between the first line inlet terminal 30a and the neutral inlet terminal 30c or between the second line inlet terminal 30b and the neutral inlet terminal 30c and a split-phase AC voltage (e.g., 240 Vac) between the first line inlet terminal 30a and the second line inlet terminal 30b.

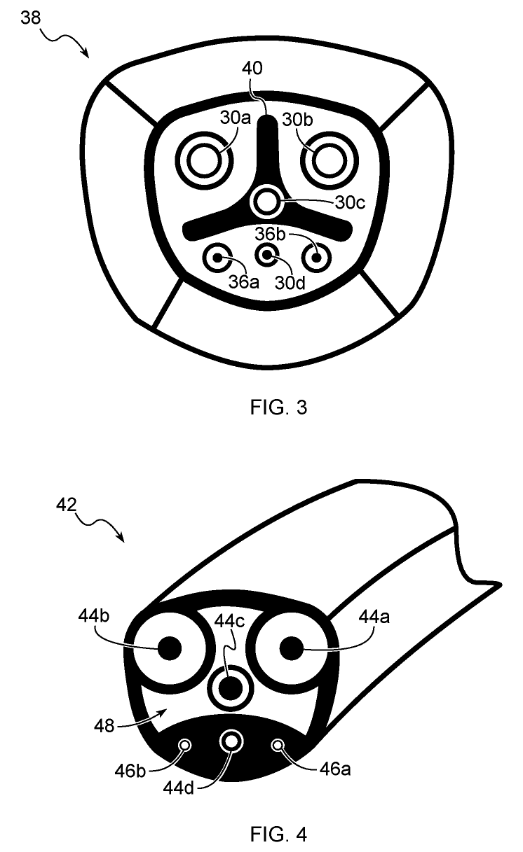

In a non-limiting example, the vehicle charging inlet 16a may be realized using any electrical connector including, for example, connectors described in standards such as International Electrotechnical Commission (IEC) 62196 (“Plugs, socket-outlets, vehicle connectors and vehicle inlets – Conductive charging of electric vehicles”), Combined Charging System (CCS) connectors, or any other suitable electrical connectors having the terminals discussed above, including separate terminals for the line inlet terminal 30a, the second line inlet terminal 30b, and the neutral inlet terminal 30c. It should be understood that the vehicle charging inlet 16a may include additional terminals for signaling, control, or other purposes, such as, for example, a control pilot (CP) inlet terminal 36a (FIG. 3), a proximity pilot (PP) inlet terminal 36b (FIG. 3), and/or the like.

In another non-limiting example, the vehicle charging inlet 16a is realized using a North American Charging System (NACS) inlet (as discussed in the Society of Automotive Engineers (SAE) J3400 standard and/or U.S. Patent No. 8,579,635, titled “FUNNEL SHAPED CHARGE INLET”, filed on July 13, 2012, the entire contents of both of which are hereby incorporated by reference) further including the neutral inlet terminal 30c. Referring to FIG. 3, a schematic diagram of a new type of North American Charging System (NACS) inlet including the neutral inlet terminal 30c, hereinafter referred to as an NACS+ inlet 38, is shown. In an exemplary embodiment, the neutral inlet terminal 30c is disposed in a center of a central divider 40 of the NACS+ inlet 38.

In a non-limiting example, a center of the neutral inlet terminal 30c is substantially equidistant from a center of the first line inlet terminal 30a and a center of the second line inlet terminal 30b. In the scope of the present disclosure, substantially equidistant means that the distances are within ±10% of each other. In a non-limiting example, the neutral inlet terminal 30c is also disposed between the first line inlet terminal 30a, the second line inlet terminal 30b, and the PE inlet terminal 30d. In a non-limiting example, the neutral inlet terminal 30c is recessed within the central divider 40 such that the NACS+ inlet 38 is backwards compatible with standard NACS connectors (i.e., NACS connectors without a neutral terminal as described in SAE J3400 and/or U.S. Patent No. 8,579,635). In a non-limiting example, the neutral inlet terminal 30c is realized as a recessed socket which accepts a corresponding pin of a connector, as will be discussed in greater detail below.

In an exemplary embodiment, the NACS+ inlet 38 is configured to connect to both a standard NACS connector (i.e., NACS connectors without a neutral terminal as described in SAE J3400 and/or U.S. Patent No. 8,579,635) and a new type of NACS connector having a neutral connector terminal 44c (FIG. 4). Referring to FIG. 4, a schematic diagram of the new type of NACS connector, hereinafter referred to as the NACS+ connector 42, is shown. In an exemplary embodiment, the NACS+ connector 42 is realized according to the SAE J3400 standard and/or U.S. Patent No. 8,579,635 but further includes the neutral connector terminal 44c. Therefore, the NACS+ connector 42 includes at least a first line connector terminal 44a, a second line connector terminal 44b, the neutral connector terminal 44c, and a protective earth (PE) connector terminal 44d. It should be understood that the NACS+ inlet 38 may include additional terminals for signaling, control, or other purposes, such as, for example, a control pilot (CP) connector terminal 46a, a proximity pilot (PP) connector terminal 46b, and/or the like.

In an exemplary embodiment, the neutral connector terminal 44c is disposed in a center of a slot 48 of the NACS+ connector 42. The slot 48 is configured to engage with the central divider 40 of the NACS+ inlet 38. In a non-limiting example, a center of the neutral connector terminal 44c is substantially equidistant from a center of the first line connector terminal 44a and a center of the second line connector terminal 44b. In the scope of the present disclosure, substantially equidistant means that the distances are within ±10% of each other. In a non-limiting example, the neutral connector terminal 44c is also disposed between the first line connector terminal 44a, the second line connector terminal 44b, and the PE connector terminal 44d. In a non-limiting example, the neutral connector terminal 44c is realized as a pin which engages with a recessed socket (i.e., the neutral inlet terminal 30c) of the NACS+ inlet 38. In a non-limiting example, the pin is retractable (e.g., spring-loaded) such that the NACS+ connector 42 is backwards compatible with standard NACS inlets (i.e., NACS inlets without a neutral terminal as described in SAE J3400 and/or U.S. Patent No. 8,579,635).

Referring again to FIG. 2, the V2L electrical outlet 16b is used to transfer energy from the battery 18 and/or the vehicle charging inlet 16a to an external device. In an exemplary embodiment, the V2L electrical outlet 16b is an AC receptacle such as, for example, a National Electrical Manufacturers Association (NEMA) 5-15 outlet, a NEMA 6-15 outlet, an International Commission on the Rules for the Approval of Electrical Equipment (IECEE) 7 outlet, and/or the like. In a non-limiting example, the V2L electrical outlet 16b is located in a passenger cabin or a cargo area of the vehicle 12. It should be understood that various additional types of receptacles may be used and that the V2L electrical outlet 16b may be realized using any type of electrical outlet without departing from the scope of the present disclosure. It should also be understood that the system 10 may include any number of V2L electrical outlets without departing from the scope of the present disclosure. In a non-limiting example, the external device is an AC load including, for example, consumer electronic devices, portable electronic devices, portable device chargers, lighting, tools, electric vehicle chargers (i.e., EVSE), etc.

In an exemplary embodiment, the V2L electrical outlet 16b includes a first line V2L terminal 50a, a second line V2L terminal 50b, a neutral V2L terminal 50c, and a protective earth (PE) V2L terminal 50d. The first line V2L terminal 50a is connected to the first line bus 28a via the switch matrix 26, as will be discussed in greater detail below. The second line V2L terminal 50b is connected to the second line bus 28b via the switch matrix 26, as will be discussed in greater detail below. The neutral V2L terminal 50c is connected to either the neutral bus 28c or the second line bus 28b depending on the state of the switch matrix 26, as will be discussed in greater detail below. The PE V2L terminal 50d is connected to the vehicle chassis ground 32 of the vehicle 12 via, for example, the outer casing 34 of the power electronics module 14.

In the single-phase mode, the V2L electrical outlet 16b provides a single-phase AC voltage (e.g., 120 Vac) between the first line V2L terminal 50a and the neutral V2L terminal 50c or between the second line V2L terminal 50b and the neutral V2L terminal 50c. In the split-phase mode, the V2L electrical outlet 16b simultaneously provides/receives the single-phase AC voltage between the first line V2L terminal 50a and the neutral V2L terminal 50c or between the second line V2L terminal 50b and the neutral V2L terminal 50c and a split-phase AC voltage (e.g., 240 Vac) between the first line V2L terminal 50a and the second line V2L terminal 50b.

The bi-directional OBCM 22 is used to transfer energy between the battery 18 and the power electronics module 14. In an exemplary embodiment, the bi-directional OBCM 22 is capable of bi-directional energy transfer to charge or discharge the battery 18. In a non-limiting example, the bi-directional OBCM 22 includes a first OBCM terminal 52a connected to the first line bus 28a and a second OBCM terminal 52b connected to the second line bus 28b. It should be understood that while the bi-directional OBCM 22 shown in FIG. 2 includes the first OBCM terminal 50a and the second OBCM terminal 52b, the bi-directional OBCM 22 may include any number of OBCM terminals, including, for example, an additional neutral OBCM terminal.

The bi-directional OBCM 22 is also in electrical communication with the battery 18 via two or more OBCM battery terminals 54. In an exemplary embodiment, the bi-directional OBCM 22 includes one or more power converters such as AC to AC converters, AC to direct current (DC) converters, DC to DC converters, and/or the like. The one or more power converters may provide galvanic isolation between the first and second OBCM terminals 52a, 52b and the OBCM battery terminals 54. It should be understood that the bi-directional OBCM 22 may include any type or combination of power converters and/or other associated components suitable for bi-directional charging and discharging of the battery 18.

The bi-directional OBCM 22 further may include circuitry, controllers, and/or software for control, monitoring, management, and/or balancing of the battery 18, including, for example, control, monitoring, and/or management of a state of charge (SOC) and/or state of health (SOH) of the battery 18. The bi-directional OBCM 22 further may include circuitry, controllers, and/or software for receiving commands and/or control signals from other controllers or devices (e.g., the controller 20) to adjust the operation of the bi-directional OBCM 22 (e.g., changing input/output voltage levels, changing power flow direction, etc.).

The AC to AC converter 24 is used to convert power received from the bi-directional OBCM 22 to suitable voltage, frequency, and phase for single-phase or split-phase output at the vehicle charging inlet 16a and/or the V2L electrical outlet 16b. The AC to AC converter 24 is also used to convert power received from the vehicle charging inlet 16a to suitable voltage, frequency, and phase for single-phase or split-phase output at the V2L electrical outlet 16b and/or transfer to the bi-directional OBCM 22. The AC to AC converter 24 is also used to convert power received from both the vehicle charging inlet 16a and the bi-directional OBCM 22 to suitable voltage, frequency, and phase for single-phase or split-phase output at the V2L electrical outlet 16b.

In a non-limiting example, the AC to AC converter 24 is realized using one or more uni- or bi-directional semiconductor switches (e.g., silicon-controlled rectifier (SCR), triode for alternating current (TRIAC), insulated-gate bipolar transistor (IGBT), metal-oxide-semiconductor field-effect transistor (MOSFET), gate turn-off thyristor (GTO), bipolar junction transistor (BJT), junction field-effect transistor (JFET), static induction transistor (SIT), emitter turn-off thyristor (ETO), integrated gate-commutated thyristor (IGCT), diode, etc.) and one or more passive components (e.g., resistor, capacitor, inductor, etc.). It should be understood that the circuit topology and components of the AC to AC converter 24 shown in FIG. 2 is merely exemplary in nature, and that the AC to AC converter 24 may be realized with any suitable circuit topology and components.

The AC to AC converter 24 further may include feedback and/or control circuitry for regulating the operation of the AC to AC converter 24. The AC to AC converter 24 further may include circuitry, controllers, and/or software for receiving commands and/or control signals from other controllers or devices (e.g., the controller 20) to adjust the operation of the AC to AC converter 24 (e.g., changing input/output voltage levels, changing power flow direction, etc.). The AC to AC converter 24 is connected to the first line bus 28a, the second line bus 28b, and the neutral bus 28c as shown in FIG. 2.

In an exemplary embodiment, the AC to AC converter 24 can be a direct AC to AC converter, such as a buck converter, a boost converter, a buck-boost converter, a Ćuk converter, indirect AC to AC converter such as a back-to-back DC link based AC to AC power converter, back-to-back AC link-based AC to AC power converter, and/or the like, including combinations and/or multiples thereof. Depending on power and voltage requirements, a suitable AC to AC converter will be selected. For example, a multiphase interleaved AC to AC converter can be used for high power implementations. It should be understood that the AC to AC converter 24 can be any suitable type of converter or combination of converters that provide the appropriate voltage magnitude and phase for each output.

The switch matrix 26 is used to adjust the operation of the power electronics module 14, for example, to switch the power electronics module 14 between the single-phase mode and the split-phase mode. In an exemplary embodiment, the switch matrix 26 includes a plurality of electrically controllable switches. The plurality of electrically controllable switches may be realized with electromechanical and/or solid-state relays, contactors, semiconductor switches (e.g., MOSFETs), and/or the like. In a non-limiting example, the plurality of electrically controllable switches includes a first electrically controllable switch 60a, a second electrically controllable switch 60b, a third electrically controllable switch 60c, a fourth electrically controllable switch 60d, and a fifth electrically controllable switch 60e.

The first electrically controllable switch 60a is configured to connect and disconnect the second line bus 28b to the neutral V2L terminal 50c and the neutral bus 28c (via the third electrically controllable switch 60c) as shown in FIG. 2. The second electrically controllable switch 60b is configured to connect and disconnect the second line bus 28b to the second line V2L terminal 50b as shown in FIG. 2. The third electrically controllable switch 60c is configured to connect and disconnect the neutral bus 28c to the neutral V2L terminal 50c, the first electrically controllable switch 60a, and the fifth electrically controllable switch 60e as shown in FIG. 2. The fourth electrically controllable switch 60d is configured to connect and disconnect the first line bus 28a to the first line V2L terminal 50a as shown in FIG. 2.

The fifth electrically controllable switch 60e is configured to connect and disconnect the neutral V2L terminal 50c, the first electrically controllable switch 60a, and the neutral bus 28c (via the third electrically controllable switch 60c) to the vehicle chassis ground 32 (e.g., via the outer casing 34) as shown in FIG. 2. The switch matrix 26 further may include circuitry, controllers, and/or software for receiving commands and/or control signals from other controllers or devices (e.g., the controller 20) to adjust the operation of the switch matrix 26 (e.g., opening/closing the plurality of electrically controllable switches, etc.). In some examples, the plurality of electrically controllable switches are controlled directly by the controller 20.

It should be understood that the above description of the power electronics module 14 is merely exemplary in nature, and that any power electronics module providing split-phase energy transfer may be used with the NACS+ inlet 38 and the NACS+ connector 42 to provide vehicle-to-home (V2H) and/or vehicle-to-grid (V2G) features within the scope of the present disclosure.

The battery 18 stores and provides electrical energy in the form of direct current (DC) for propulsion and/or other features of the vehicle 12. In an exemplary embodiment, the battery 18 includes a plurality of battery cells (e.g., lithium-ion battery cells) electrically connected in series and/or parallel to provide an increased voltage and/or current-carrying capacity. In an exemplary embodiment, the battery 18 further includes a battery management system (BMS) configured to monitor battery characteristics such as a state of charge (SOC), state of health (SOH), temperature, and/or the like, and transmit the battery characteristics to the controller 20 and/or other devices/computers of the vehicle 12. In an exemplary embodiment, the battery 18 provides a DC voltage across a positive and negative output terminal. The positive and negative output terminals are electrically connected to the OBCM battery terminals 54 of the bi-directional OBCM 22 as discussed above. The positive and negative output terminals are also electrically connected to loads such as, for example, an electric motor drive inverter (not shown).

Referring again to FIG. 1, the controller 20 is used to implement a method 100 for operating the vehicle power electronics system 10, as will be described below. The controller 20 includes at least one processor 70 and a non-transitory computer readable storage device or media 72. The processor 70 may be a custom made or commercially available processor, a central processing unit (CPU), a graphics processing unit (GPU), an auxiliary processor among several processors associated with the controller 20, a semiconductor-based microprocessor (in the form of a microchip or chip set), a macroprocessor, a combination thereof, or generally a device for executing instructions.

The computer readable storage device or media 72 may include volatile and nonvolatile storage in read-only memory (ROM), random-access memory (RAM), and keep-alive memory (KAM), for example. KAM is a persistent or non-volatile memory that may be used to store various operating variables while the processor 70 is powered down. The computer-readable storage device or media 72 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the controller 20 to control the vehicle power electronics system 10 and/or various systems of the vehicle 12.

The controller 20 may also include multiple controllers which are in electrical communication with each other. The controller 20 may be inter-connected with additional systems and/or controllers of the vehicle 12, allowing the controller 20 to access data such as, for example, speed, acceleration, braking, and steering angle of the vehicle 12.

The controller 20 is in electrical communication with at least the power electronics module 14 and the battery 18. In an exemplary embodiment, the electrical communication is established using, for example, a CAN network, a FLEXRAY network, a local area network (e.g., WiFi, ethernet, and the like), a serial peripheral interface (SPI) network, or the like. It should be understood that various additional wired and wireless techniques and communication protocols for communicating with the controller 20 are within the scope of the present disclosure. It should further be understood that, in the scope of the present disclosure, electrical communication also includes power and/or energy transfer between electrical devices (e.g., using conducting wires and/or wireless power transmission techniques).

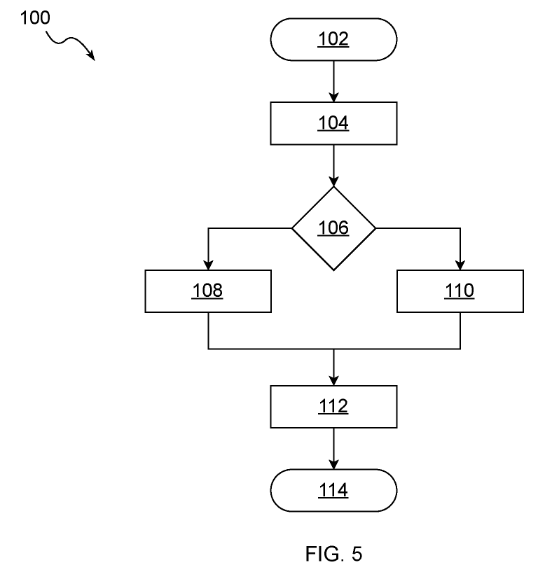

Referring to FIG. 5, a flowchart of the method 100 for operating the vehicle power electronics system 10 is shown. The method 100 begins at block 102 and proceeds to block 104. At block 104, EVSE is connected to the vehicle charging inlet 16a. In a non-limiting example, the NACS+ connector 42 of the EVSE is connected to the NACS+ inlet 38 of the vehicle 12, providing two AC phase connections (i.e., the first line inlet terminal 30a and the second line inlet terminal 30b) and a neutral connection (i.e., the neutral inlet terminal 30c) between the EVSE and the vehicle power electronics system 10.

In an exemplary embodiment, the EVSE is connected to a building electrical panel (e.g., for a vehicle-to-home (V2H) application). In a non-limiting example, the EVSE is configured to provide a connection between the first line inlet terminal 30a of the vehicle charging inlet 16a and a first AC phase bus of the building electrical panel. The EVSE is further configured to provide a connection between the second line inlet terminal 30b of the vehicle charging inlet 16a and a second AC phase bus of the building electrical panel. The EVSE is further configured to provide a connection between the neutral inlet terminal 30c of the vehicle charging inlet 16a and a neutral bus of the building electrical panel. It should be understood that the building electrical panel may include any component of a building electricity supply system that is configured to divide an electrical power feed into subsidiary circuits while providing a protective fuse (e.g., circuit breaker) for each circuit in one or more common and/or distributed enclosure(s). In a non-limiting example, the building electrical panel includes a circuit breaker panel, a fuse box, a junction box, and/or the like of a residential and/or commercial building.

In another exemplary embodiment, the EVSE is connected to a public electrical grid (e.g., for a vehicle-to-grid (V2G) application). In a non-limiting example, the EVSE is configured to provide a connection between the first line inlet terminal 30a of the vehicle charging inlet 16a and a first AC phase bus of the public electrical grid. The EVSE is further configured to provide a connection between the second line inlet terminal 30b of the vehicle charging inlet 16a and a second AC phase bus of the public electrical grid. The EVSE is further configured to provide a connection between the neutral inlet terminal 30c of the vehicle charging inlet 16a and a neutral bus of the public electrical grid.

In an exemplary embodiment, at block 104, the EVSE is connected to the vehicle charging inlet 16a manually by a user of the vehicle 12 and/or the EVSE. In another exemplary embodiment, the EVSE is connected to the vehicle charging inlet 16a automatically by a mechanical, electromechanical, and/or robotic system configured to, for example, insert the NACS+ connector 42 of the EVSE into the NACS+ inlet 38 of the vehicle 12. In an exemplary embodiment, at block 104, an electrical load is also connected to the V2L electrical outlet 16b. After block 104, the method 100 proceeds to block 106.

At block 106, a voltage configuration operational mode for the power electronics module 14 is determined. As discussed above, the power electronics module 14 may be operated in a single-phase mode or a split-phase mode. In an exemplary embodiment, the controller 20 determines the voltage configuration operational mode based on inputs, settings, or selections received from a user of the vehicle 12 and/or the EVSE via, for example, an interface of the vehicle 12, the EVSE, or a mobile device application. In another exemplary embodiment, the controller 20 determines the voltage configuration operational mode by sensing or detection of voltages present on the first line inlet terminal 30a, the second line inlet terminal 30b, and/or the neutral inlet terminal 30c. In yet another exemplary embodiment, the controller 20 determines the voltage configuration operational mode by sensing or detecting electrical characteristics of an electrical load connected to the V2L electrical outlet 16b. If the voltage configuration operational mode is selected to be the single-phase mode, the method 100 proceeds to block 108. If the voltage configuration operational mode is selected to be the split-phase mode, the method 100 proceeds to block 110.

At block 108, the controller 20 configures the switch matrix 26 for single-phase mode. In an exemplary embodiment, to configure the switch matrix 26 for single-phase mode, the controller 20 closes the first electrically controllable switch 60a, opens the second electrically controllable switch 60b, opens the third electrically controllable switch 60c, and closes the fourth electrically controllable switch 60d. In the scope of the present disclosure, a “closed” switch provides continuity and conducts current while an “open” switch does not provide continuity and does not conduct current. In another exemplary embodiment, the plurality of internal switches (not shown) of the vehicle charging inlet 16a are used to disconnect the second line inlet terminal 30b from the second line bus 28b. In a non-limiting example, the fifth electrically controllable switch 60e may be either opened or closed to provide either a floating neutral or a bonded neutral configuration, respectively. After block 108, the method 100 proceeds to block 112.

At block 110, the controller 20 configures the switch matrix 26 for split-phase mode. In an exemplary embodiment, to configure the switch matrix 26 for split-phase mode, the controller 20 opens the first electrically controllable switch 60a, closes the second electrically controllable switch 60b, closes the third electrically controllable switch 60c, and closes the fourth electrically controllable switch 60d. In another exemplary embodiment, the plurality of internal switches (not shown) of the vehicle charging inlet 16a are used to connect the first line inlet terminal 30a, the second line inlet terminal 30b, and the neutral inlet terminal 30c to the first line bus 28a, the second line bus 28b, and the neutral bus 28c, respectively. In a non-limiting example, the fifth electrically controllable switch 60e may be either opened or closed to provide either a floating neutral or a bonded neutral configuration, respectively. After block 110, the method 100 proceeds to block 112.

At block 112, the power electronics module 14 is configured for a desired energy flow. In an exemplary embodiment, the controller 20 determines the desired energy flow based on inputs, settings, or selections received from a user of the vehicle 12 and/or the EVSE via, for example, an interface of the vehicle 12, the EVSE, or a mobile device application. In another exemplary embodiment, the controller 20 determines the desired energy flow by sensing or detection of voltages present on the first line inlet terminal 30a, the second line inlet terminal 30b, and/or the neutral inlet terminal 30c. In yet another exemplary embodiment, the controller 20 determines the desired energy flow by sensing or detecting electrical characteristics of an electrical load connected to the V2L electrical outlet 16b.

In a non-limiting example, the desired energy flow is energy flowing into the power electronics module 14 via the vehicle charging inlet 16a and being used to simultaneously charge the battery 18 (i.e., provide a vehicle battery charging feature) via the bi-directional OBCM 22 and to power an electrical load via the AC to AC converter 24 and the V2L electrical outlet 16b (i.e., provide a V2L feature). In another non-limiting example, the desired energy flow is energy flowing into the power electronics module 14 via the vehicle charging inlet 16a and being used either solely to charge the battery 18 (i.e., provide a vehicle battery charging feature) or solely to power the electrical load via the AC to AC converter 24 and the V2L electrical outlet 16b (i.e., provide a V2L feature).

In another non-limiting example, the desired energy flow is energy flowing into the power electronics module 14 via the vehicle charging inlet 16a and being used to power the electrical load via the AC to AC converter 24 and the V2L electrical outlet 16b while the battery 18 is discharged by the bi-directional OBCM 22 to provide additional power to the electrical load via the AC to AC converter 24 and the V2L electrical outlet 16b (i.e., provide a V2L feature). In another non-limiting example, the desired energy flow is energy flowing out of the battery 18 via the bi-directional OBCM 22 and being used to provide power to the building electrical panel (i.e., provide a vehicle-to-home (V2H) feature) and/or to provide power to a public electrical grid (i.e., provide a vehicle-to-grid (V2G) feature) via the vehicle charging inlet 16a and/or to provide power to the V2L electrical outlet 16b (i.e., provide a V2L feature). It should be understood that the energy flows discussed above are merely exemplary in nature, and that additional energy flows are within the scope of the present disclosure.

In an exemplary embodiment, to configure the power electronics module 14 for the desired energy flow, the controller 20 adjusts one or more operating characteristics of the vehicle charging inlet 16a, the bi-directional OBCM 22, the AC to AC converter 24, and/or the switch matrix 26. In a non-limiting example, the controller 20 controls the plurality of internal switches (not shown) of the vehicle charging inlet 16a to connect/disconnect the vehicle charging inlet 16a to/from the first line bus 28a, the second line bus 28b, and the neutral bus 28c. In a non-limiting example, the controller 20 adjusts an input/output voltage, phase, frequency, power flow direction, and/or the like of the bi-directional OBCM 22 and/or the AC to AC converter 24. In a non-limiting example, the controller 20 controls the switch matrix 26 to connect/disconnect the V2L electrical outlet 16b to/from the first line bus 28a, the second line bus 28b, and the neutral bus 28c. It should be understood that additional actions by the controller 20 to configure the power electronics module 14 for the desired energy flow are also within the scope of the present disclosure. After block 112, the method 100 proceeds to enter a standby state at block 114.

In an exemplary embodiment, the controller 14 repeatedly exits the standby state 114 and restarts the method 100 at block 102. In a non-limiting example, the controller 14 exits the standby state 114 and restarts the method 100 on a timer, for example, every three hundred milliseconds.

The system 10 and method 100 of the present disclosure offer several advantages. Using the system 10 and method 100, the vehicle 12 may be used to provide a vehicle-to-home (V2H) feature to a connected building while also providing a neutral connection to the connected building, eliminating the need for external neutral generation. Therefore, size, weight, and resource use of EVSE is reduced because neutral generation equipment (e.g., autotransformers) is no longer needed. Furthermore, the system 10 and method 100 allow the vehicle 12 to provide the V2H feature without a need for specialized EVSE. Additionally, the use of the new NACS+ connector and inlet in the system 10 and method 100 allow the vehicle 12 to provide the neutral connection to the connected building while also maintaining backwards compatibility with existing NACS EVSE.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A power electronics system for a vehicle, the power electronics system comprising:
a vehicle charging inlet including a first line inlet terminal, a second line inlet terminal, and a neutral inlet terminal;
a vehicle-to-load (V2L) electrical outlet for providing AC power to an external device, wherein the V2L electrical outlet includes a first line V2L terminal, a second line V2L terminal, and a neutral V2L terminal in electrical communication with the vehicle charging inlet;
a bi-directional on-board charging module (OBCM) in electrical communication a battery of the vehicle; and
an alternating current (AC) to AC converter in electrical communication with the vehicle charging inlet, the V2L electrical outlet, and the bi-directional OBCM.

2. The power electronics system of claim 1, the power electronics system further comprising:
a switch matrix connecting the V2L electrical outlet to the vehicle charging inlet, the AC to AC converter, and the bi-directional OBCM, the switch matrix including a plurality of electrically controllable switches for operating the power electronics system in a single-phase mode or a split-phase mode;
a first line bus connecting the first line inlet terminal of the vehicle charging inlet to the first line V2L terminal of the V2L electrical outlet and a first OBCM terminal of the bi-directional OBCM;
a second line bus connecting the second line inlet terminal of the vehicle charging inlet to the second line V2L terminal of the V2L electrical outlet and a second OBCM terminal of the bi-directional OBCM; and
a neutral bus connecting the neutral inlet terminal of the vehicle charging inlet to the neutral V2L terminal of the V2L electrical outlet.

3. The power electronics system of claim 2, wherein in the split-phase mode, the V2L electrical outlet is configured to simultaneously provide both a single-phase AC voltage between either the first line V2L terminal or the second line V2L terminal and the neutral V2L terminal and a split-phase AC voltage between the first line V2L terminal and the second line V2L terminal.

4. The power electronics system of claim 2, wherein in the split-phase mode, the vehicle charging inlet is configured to simultaneously provide both a single-phase AC voltage between either the first line inlet terminal or the second line inlet terminal and the neutral inlet terminal and a split-phase AC voltage between the first line inlet terminal and the second line inlet terminal.

5. The power electronics system of claim 4, the plurality of electrically controllable switches further comprising:
a first electrically controllable switch configured to connect and disconnect the neutral bus to the second line bus; and
a second electrically controllable switch configured to connect and disconnect the second line V2L terminal to the second line bus.

6. The power electronics system of claim 5, the plurality of electrically controllable switches further comprising:
a third electrically controllable switch configured to connect and disconnect the neutral V2L terminal and the first electrically controllable switch to the neutral bus;
a fourth electrically controllable switch configured to connect and disconnect the first line V2L terminal to the first line bus; and
a fifth electrically controllable switch configured to connect and disconnect the neutral bus to a vehicle chassis ground.

7. The power electronics system of claim 5, the power electronics system further comprising:
a controller in electrical communication with the bi-directional OBCM, the AC to AC converter, and the plurality of electrically controllable switches, wherein the controller is programmed to:
configure the bi-directional OBCM, the AC to AC converter, and the plurality of electrically controllable switches to operate in one of: the single-phase mode and the split-phase mode to transfer energy from the bi-directional OBCM to the vehicle charging inlet and/or the V2L electrical outlet to provide a vehicle-to-home (V2H) feature and/or a vehicle-to-load (V2L) feature; and
configure the bi-directional OBCM, the AC to AC converter, and the plurality of electrically controllable switches to operate in one of: the single-phase mode and the split-phase mode to transfer energy from the vehicle charging inlet to the bi-directional OBCM to provide a vehicle battery charging feature.

8. The power electronics system of claim 7, wherein:
to operate in the single-phase mode, the controller is further programmed to close the first electrically controllable switch and open the second electrically controllable switch; and
to operate in the split-phase mode, the controller is further programmed to open the first electrically controllable switch and close the second electrically controllable switch.

9. The power electronics system of claim 4, the vehicle charging inlet further comprising:
a North American Charging System (NACS) inlet including the first line inlet terminal, the second line inlet terminal, and the neutral inlet terminal.

10. The power electronics system of claim 9, wherein the neutral inlet terminal is disposed substantially in a center of the NACS inlet, and wherein the NACS inlet is backwards compatible with NACS connectors without neutral terminals.

11. A method for operating a vehicle power electronics system, the method comprising:
connecting a building electrical panel to a vehicle charging inlet of the vehicle power electronics system, wherein the vehicle power electronics system includes the vehicle charging inlet including a first line inlet terminal, a second line inlet terminal, and a neutral inlet terminal, a bi-directional on-board charging module (OBCM) in electrical communication a battery of the vehicle, wherein the bi-directional OBCM includes a first OBCM terminal and a second OBCM terminal in electrical communication with the vehicle charging inlet, and an alternating current (AC) to AC converter in electrical communication with the vehicle charging inlet and the bi-directional OBCM;
operating the vehicle power electronics system in one of: a single-phase mode and a split-phase mode, wherein in the split-phase mode, the vehicle charging inlet is configured to simultaneously provide or receive both a single-phase AC voltage to or from the building electrical panel between either the first line inlet terminal or the second line inlet terminal and the neutral inlet terminal and a split-phase AC voltage to or from the building electrical panel between the first line inlet terminal and the second line inlet terminal; and
transferring energy from the battery of the vehicle to the building electrical panel using the vehicle power electronics system to provide power to the building electrical panel.

12. The method of claim 11, further comprising:
connecting the vehicle charging inlet to the bi-directional OBCM with a first line bus connecting the first line inlet terminal of the vehicle charging inlet to the first OBCM terminal of the bi-directional OBCM and the AC to AC converter, a second line bus connecting the second line inlet terminal of the vehicle charging inlet to the second OBCM terminal of the bi-directional OBCM and the AC to AC converter, and a neutral bus connecting the neutral inlet terminal of the vehicle charging inlet to the AC to AC converter.

13. The method of claim 12, wherein operating the vehicle power electronics system in the single-phase mode further comprises:
closing a first electrically controllable switch, wherein the first electrically controllable switch is configured to connect and disconnect the neutral bus to the second line bus.

14. The method of claim 12, wherein operating the vehicle power electronics system in the split-phase mode further comprises:
opening a first electrically controllable switch, wherein the first electrically controllable switch is configured to connect and disconnect the neutral bus to the second line bus.

15. The method of claim 12, further comprising:
transferring energy from the battery of the vehicle to an external device using a vehicle-to-load (V2L) electrical outlet, wherein the V2L electrical outlet includes a first line V2L terminal in electrical communication with the first line bus, a second line V2L terminal in electrical communication with the second line bus, and a neutral V2L terminal in electrical communication with the neutral bus, and wherein in the split-phase mode, the V2L electrical outlet is configured to simultaneously provide both a single-phase AC voltage between either the first line V2L terminal or the second line V2L terminal and the neutral V2L terminal and a split-phase AC voltage between the first line V2L terminal and the second line V2L terminal.

16. The method of claim 11, wherein connecting the building electrical panel to the vehicle charging inlet further comprises:
connecting the building electrical panel to the vehicle charging inlet using a North American Charging System (NACS) connector in electrical communication with the building electrical panel, wherein the NACS connector includes a first line connector terminal configured to contact the first line inlet terminal of the vehicle charging inlet, a second line connector terminal configured to contact the second line inlet terminal of the vehicle charging inlet, and a neutral connector terminal configured to contact the neutral inlet terminal of the vehicle charging inlet.

17. The method of claim 11, further comprising:
transferring energy from the building electrical panel to the battery of the vehicle using the vehicle power electronics system to charge the battery of the vehicle.

18. A power electronics system for a vehicle, the power electronics system comprising:
a North American Charging System (NACS) inlet including a first line inlet terminal, a second line inlet terminal, and a neutral inlet terminal, wherein a center of the neutral inlet terminal is substantially equidistant from a center of the first line inlet terminal and a center of the second line inlet terminal, and wherein the NACS inlet is configured to simultaneously provide or receive both a single-phase AC voltage between either the first line inlet terminal or the second line inlet terminal and the neutral inlet terminal and a split-phase AC voltage between the first line inlet terminal and the second line inlet terminal;
a vehicle-to-load (V2L) electrical outlet for providing AC power to an external device, wherein the V2L electrical outlet includes a first line V2L terminal, a second line V2L terminal, and a neutral V2L terminal in electrical communication with the NACS inlet;
a bi-directional on-board charging module (OBCM) in electrical communication a battery of the vehicle, wherein the bi-directional OBCM includes a first OBCM terminal and a second OBCM terminal in electrical communication with the NACS inlet and the V2L electrical outlet;
an alternating current (AC) to AC converter in electrical communication with the NACS inlet, the V2L electrical outlet, and the bi-directional OBCM; and
a switch matrix connecting the V2L electrical outlet to the NACS inlet, the AC to AC converter, and the bi-directional OBCM, the switch matrix including a plurality of electrically controllable switches for operating the power electronics system in a single-phase mode or a split-phase mode.

19. The power electronics system of claim 18, further comprising:
a first line bus connecting the first line inlet terminal of the NACS inlet to the first line V2L terminal of the V2L electrical outlet and the first OBCM terminal of the bi-directional OBCM;
a second line bus connecting the second line inlet terminal of the NACS inlet to the second line V2L terminal of the V2L electrical outlet and the second OBCM terminal of the bi-directional OBCM;
a neutral bus connecting the neutral inlet terminal of the NACS inlet to the neutral V2L terminal of the V2L electrical outlet;
a first electrically controllable switch configured to connect and disconnect the neutral bus to the second line bus; and
a second electrically controllable switch configured to connect and disconnect the second line V2L terminal to the second line bus.

20. The power electronics system of claim 19, the power electronics system further comprising:
a controller in electrical communication with the bi-directional OBCM, the AC to AC converter, and the plurality of electrically controllable switches, wherein the controller is programmed to:
close the first electrically controllable switch and open the second electrically controllable switch to operate the power electronics system in the single-phase mode; and
open the first electrically controllable switch and close the second electrically controllable switch to operate the power electronics system in the split-phase mode.
